(19) United States
(12) Patent Application Publication
(10) Pub. No.: US 2019/0031193 A1
(43) Pub. Date: Jan. 31, 2019

(54) TRAVEL CONTROL DEVICE FOR VEHICLE

(71) Applicant: HITACHI AUTOMOTIVE SYSTEMS, LTD., Hitachinaka-shi, Ibaraki (JP)

(72) Inventor: Takao KOJIMA, Tokyo (JP)

(73) Assignee: HITACHI AUTOMOTIVE SYSTEMS, LTD., Hitachinaka-shi, Ibaraki (JP)

(21) Appl. No.: 16/072,327

(22) PCT Filed: Jan. 25, 2017
(86) PCT No.: PCT/JP2017/002414

§ 371 Date: Jul. 24, 2018

(30) Foreign Application Priority Data
Mar. 31, 2016 (JP) 2016-069942

(51) Int. Cl. B60W 30/165; G01C 21/32; G01C 21/34; G06K 9/00; G05D 1/00; G05D 1/02

(52) U.S. Cl. CPC B60W 30/165; G01C 21/32; G01C 21/3415; G05D 2201/0213; G06K 9/00798; G05D 1/0088; G05D 1/0246; G06K 9/00825

(57) ABSTRACT

The present invention provides a travel control device which is capable, even if map information differs from an actual environment, of generating an appropriate travel route on the basis of a travel environment. Provided is a travel control device for a vehicle, comprising: a travel route computation means which computes a travel route of a host vehicle on the basis of acquired map information; a travel environment recognition means which detects a travel environment in the vicinity of the host vehicle; a travel trajectory computation means which computes a travel trajectory of another vehicle which is detected with the travel environment recognition means; and a route planning means which plans a target route which the host vehicle travels. The route planning means comprises a correction means which, if the travel route differs from the travel environment, corrects the target route on the basis of the travel trajectory of the other vehicle.

### TECHNICAL FIELD

The present invention relates to a travel control device for vehicle having a function of performing travel control so as to follow a set route.

### BACKGROUND ART

In recent years, techniques for performing autonomous traveling while recognizing a travel environment in the vicinity of a vehicle have been variously proposed. For example, PTL 1 discloses a technique for generating a plan for safe traveling according to a travel environment in the vicinity of a vehicle.

### CITATION LIST

### Patent Literature

PTL 1: JP 2009-037561 A

### SUMMARY OF INVENTION

### Technical Problem

However, the technique disclosed in PTL 1 generates a reference route on the basis of map information. In other words, with conventional vehicle control using a map, appropriate traveling according to an actual environment may not be performed if the map differs from the actual environment due to the delay in updating the map or the like.

Thus, a purpose of the present invention is to provide a travel control device which is capable, when map information differs from an actual environment, of generating an appropriate travel route according to a travel environment.

### Solution to Problem

In order to solve the above problem, a travel control device for vehicle of the present invention includes, for example, a travel route computation means for computing a travel route of a host vehicle on the basis of acquired map information, a travel environment recognition means for detecting a travel environment in the vicinity of the host vehicle, a travel trajectory computation means for computing a travel trajectory of another vehicle detected by the travel environment recognition means, and a route planning means for planning a target route on which the host vehicle travels. The route planning means includes a correction means for correcting, when the travel route differs from the travel environment, the target route on the basis of the travel trajectory of the other vehicle.

### Advantageous Effects of Invention

When map information differs from an actual road shape, it is possible to generate a safe and appropriate route to continue travel control of a vehicle.

### BRIEF DESCRIPTION OF DRAWINGS

FIG. 1 is a diagram showing a vehicle provided with a travel control device for vehicle according to the present invention.

FIG. 2 is a diagram showing an example of map information held by a map unit.

FIG. 3 is a diagram showing an example of position estimation processing of the map unit.

FIG. 4 is a diagram showing an embodiment of the travel control device for vehicle.

FIG. 5 is flowchart showing processing for route correction.

FIG. 6 is a diagram showing an example of a travel environment in which map information differs from an actual environment.

FIG. 7 is a diagram showing an example of processing corresponding to S102 and S103 of the flowchart.

FIG. 8 is a diagram showing an example of processing corresponding to S104 of the flowchart.

FIG. 9 is a diagram showing an example of processing corresponding to S105 to S108 of the flowchart.

FIG. 10 is a diagram showing an embodiment of a travel control device for vehicle including a wireless communication unit.

FIG. 11 is a diagram showing an example of processing corresponding to S104 of the flowchart.

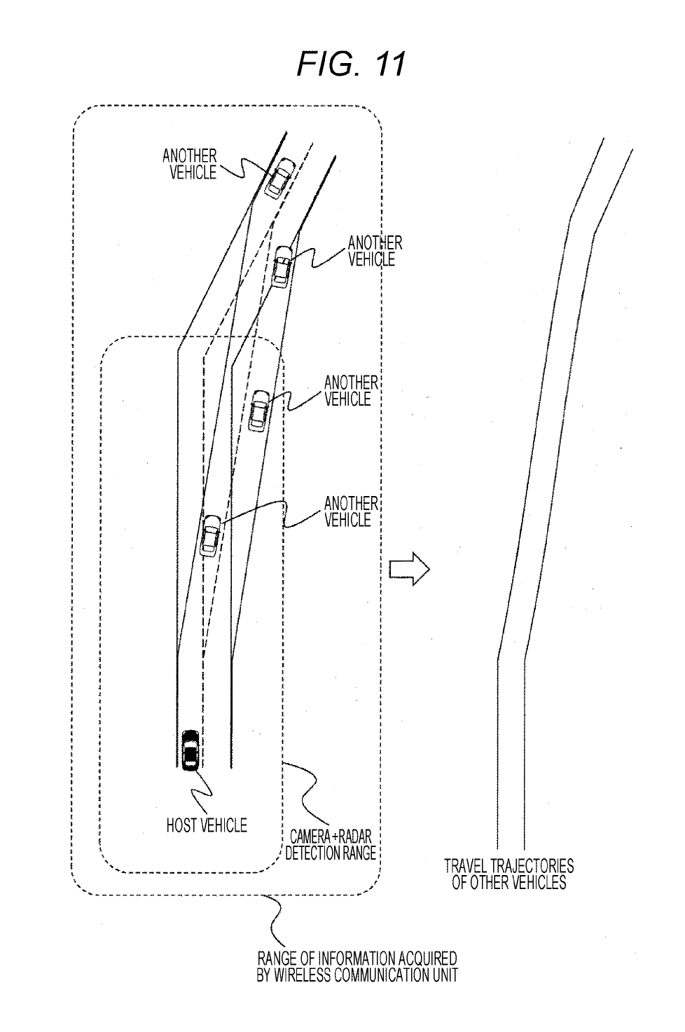

FIG. 12 is a diagram showing an example of processing corresponding to S105 to S108 of the flowchart.

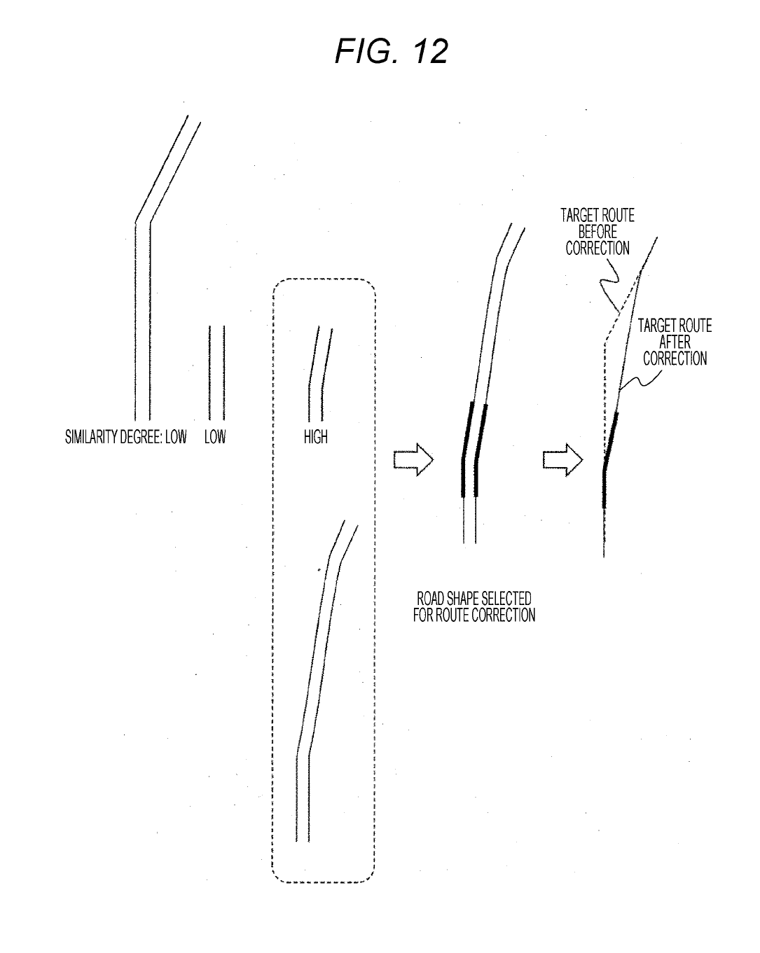

### DESCRIPTION OF EMBODIMENTS

Hereinafter, an embodiment of the present invention is described in detail with reference to the drawings.

First, a first embodiment of the present invention is described with reference to the drawings.

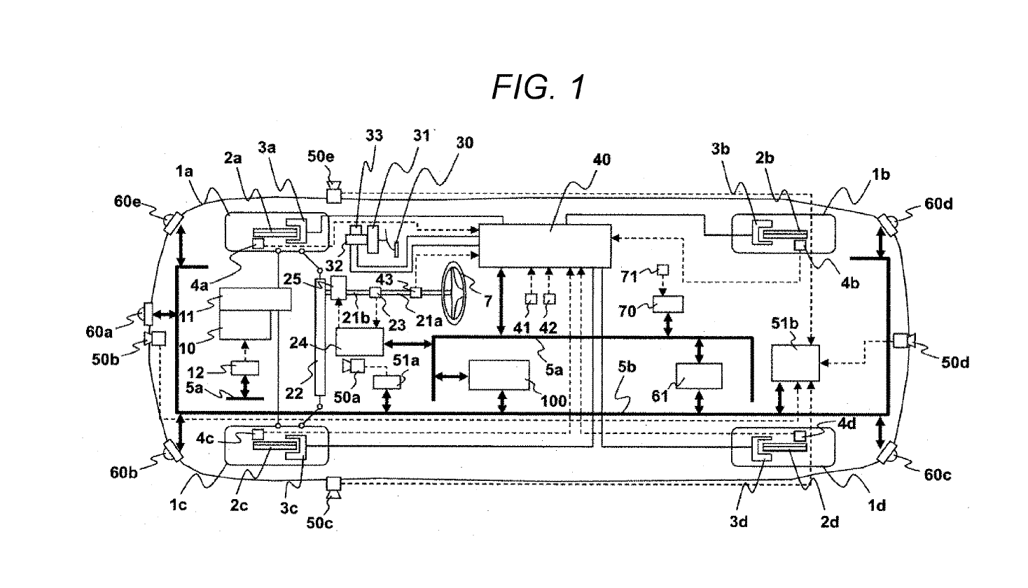

FIG. 1 is a schematic configuration diagram of a vehicle that is provided with a travel control device for vehicle according to the present invention and capable of controlling the traveling of the vehicle by electronic control on the basis of map information and information on various sensors.

The vehicle includes wheels 1a to 1d, and is driven by transmitting the output of an engine 10 to the wheels 1a and 1c via a transmission 11.

The steering can be electronically controlled, and includes a steering wheel 20, a steering shaft 21 (an input shaft 21a and an output shaft 21b), a steering torque sensor 23, a steering rack 22, a steering control unit 24, and a steering actuator 25. The steering torque sensor 23 is what is called a torsion bar, and detects the torque applied between the input and output shafts caused by the torsion between the input shaft 21a and the output shaft 22b. The steering control unit 24 controls the output amount of the steering actuator 25 according to the output of the steering torque sensor 23.

A brake pedal 30 is provided with a booster 31, a master cylinder 32, and a reservoir tank 33. Generally, a force of the driver's stepping on the brake pedal 30 (pedal force) is boosted by the booster 31 and is transmitted to wheel cylinders 3a to 3d. A brake pad (not shown) is pressed against brake rotors 2a to 2d, which rotate integrally with the wheels 1a to 1d, by the pedal force transmitted to the wheel cylinders 3a to 3d to generate a braking force. A brake control unit 40 provided between the master cylinder 32 and the wheel cylinders 3a to 3d can independently increase or decrease the fluid pressure to the wheel cylinders 3a to 3d on the basis of the respective outputs of wheel speed sensors 4a to 4d, a steering angle sensor 43, a yaw rate sensor 41, and a lateral acceleration sensor 42.

A camera 50 can acquire images of the vicinity of the host vehicle using an image sensor of a charge coupled device (CCD) system or a complementary metal oxide semiconductor (CMOS) system. By processing the images acquired by the camera 50, a camera control unit 51 can recognize information on traffic rules such as road dividing lines, stop lines, pedestrian crossings, signals, and signs, and obstacles such as vehicles and pedestrians, and can detect them as position information setting the host vehicle as a reference. In FIG. 1, a single camera is provided, but image information acquired by two or more cameras may be used. For example, by using a known stereo recognition technology using parallax, a travel environment ahead of the host vehicle may be recognized and reflected in the travel control.

A radar 60 is a device that emits a radio wave or a light beam and detects the positional relationship and the relative speed between the vehicle and an object on the basis of the reflected wave, and can provide the detected information to the other control units via a vehicle control network 5.

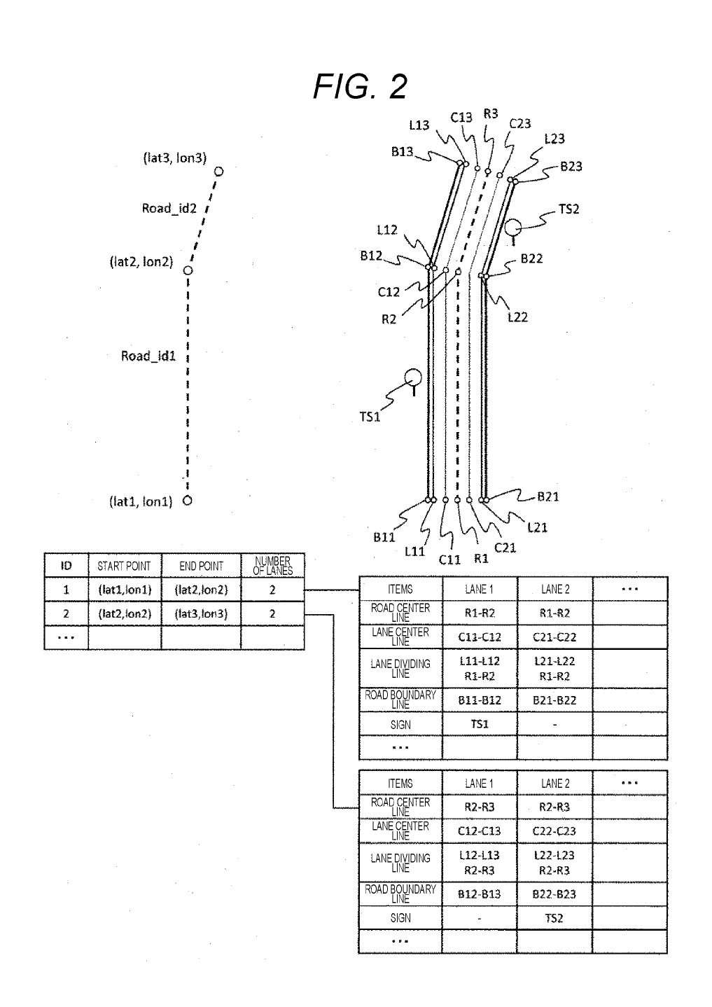

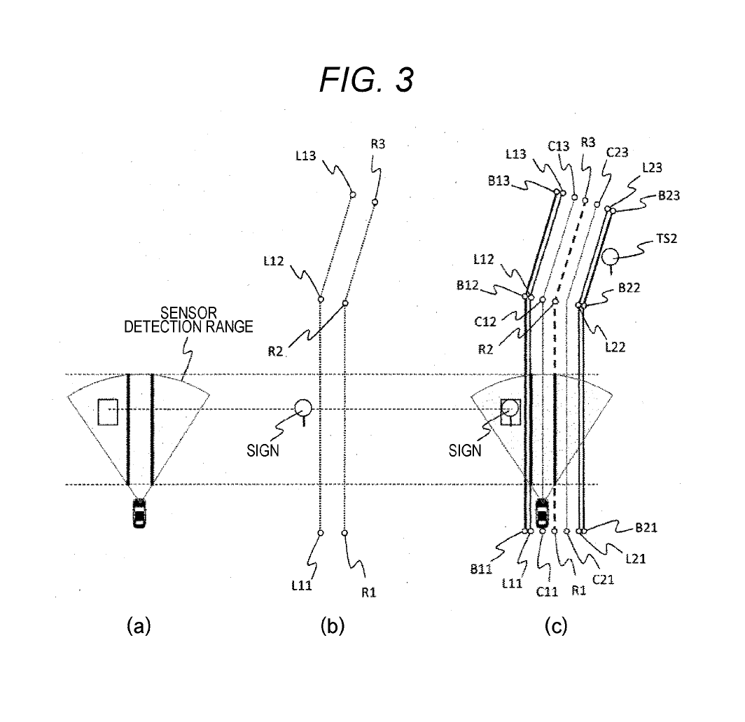

A map unit 70 provides map information held inside to each controller according to the traveling condition of the vehicle. The map information includes, as shown in FIG. 2, information on the number of lanes to be managed on a road-by-road basis and the general structures of roads, and, as further detailed information, information on road shapes, lane-based information (positions and shapes related to road markings such as road dividing lines and stop lines), and positions of signs and signals. As shown in FIG. 3, the vehicle further has a function of estimating the position and direction of the host vehicle on the basis of the result (FIG. 3(c)) obtained by comparing the information on the travel environment detected by a positioning sensor 71, the camera 50, and a radar unit 60 (FIG. 3(a)) with the map information (FIG. 3(b)).

A travel control device for vehicle 100 can transmit and receive information to and from the control units (24, 40, 51, and 60) and other control units (not shown) of the vehicle via the vehicle control network 5 (a part of which is shown), acquire sensor values of the other control units, and output a command such as a control amount and an instruction of the correction value to the other control units.

The control system of the vehicle is constituted by a large number of sensors and controllers and exchanges information via a network, and which can increase the communication load of the network. Thus, the control system may be constituted by a plurality of networks having the same or different types of communication protocols according to the type of information, and selectively exchange information between mutual networks using a gateway unit 61.

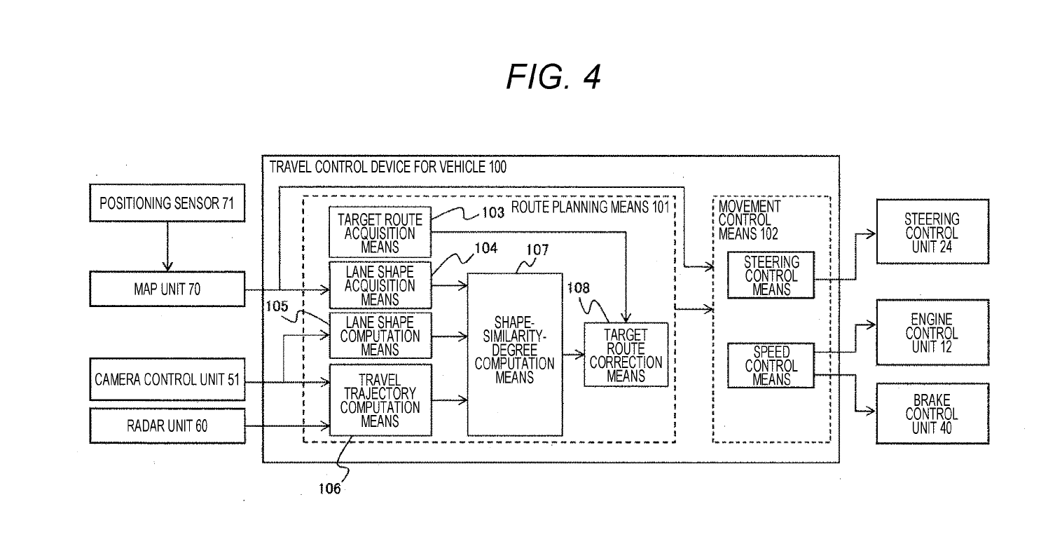

Next, the travel control device for vehicle 100 according to the present invention is described with reference to FIG. 4. The travel control device for vehicle 100 includes a route planning means 101 and a movement control means 102. The route planning means 101 plans a route along which the host vehicle travels on the basis of the information of the map unit 70, the camera 50, and the radar unit 60. The movement control means 102 transmits, as commands, target control amounts to the steering control unit 24, the engine control unit 12, and the brake control unit 40 on the basis of the position of the host vehicle acquired from the map unit 70 and the target route output by the route planning means 101 so that the host vehicle travels along the target route.

The route planning means 101 is constituted by a target route acquisition means 103, a lane shape acquisition means 104, a lane shape computation means 105, a travel trajectory computation means 106, a lane-shape-similarity-degree computation means 107, a shape selection means 108, and a target route correction means 109.

The lane shape acquisition means 104 acquires shape information on the traveling lane (lane) in the vicinity of the host vehicle from the map unit 70 on the basis of the current position of the host vehicle. For example, when the host vehicle is traveling on the lane 1 in FIG. 2, the position information on the road center line and the like relating to the lane 1 corresponds to the shape information.

The lane shape computation means 105 is processing for detecting the lane dividing line (lane) and the road boundary (road edge) of the road by the sensors and estimating the lane shape on the basis of the information, and computes, for example, the information corresponding to the road center line of the lane 1 in FIG. 2 on the basis of the sensor information.

The travel trajectory computation means 106 accumulates the information on the positions and speeds of surrounding vehicles detected by the sensors from a certain past time to the present time, and computes the travel trajectories of the surrounding vehicles on the basis of the history information. When the surrounding vehicles do not change lanes and travels along the road dividing line shown in FIG. 2, the computed travel trajectories have a shape similar to the lane center line in FIG. 2.

On the basis of the lane shape information output by the lane shape acquisition means 104 and the lane shape computation means 105 and the shape of the travel trajectories of the surrounding vehicles output by the travel trajectory computation means 106, a shape-similarity-degree computation means 107 computes the similarity of the shape. As a result of the computation, when there is a lane shape having a similarity degree equal to or greater than a predetermined value, the shape information is output.

A route correction means 108 compares the current target route acquired by the target route acquisition means 103 with the lane shape output by the shape-similarity-degree computation means 107, and corrects the target route on the basis of the output of the shape-similarity-degree computation means 107 when the target route differs from the lane shape.

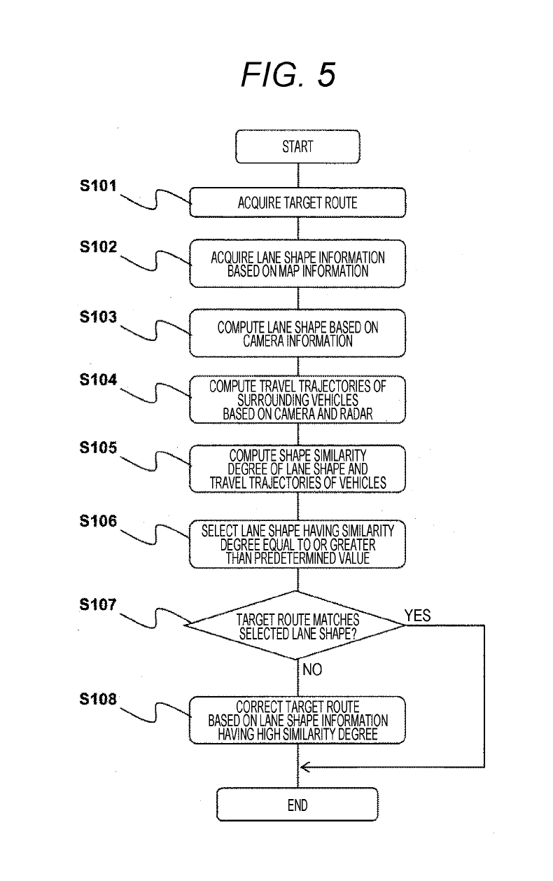

FIG. 5 is a flowchart showing processing for correcting the target route in the travel control device for vehicle 100. First, in step S101, information on the current target route stored in a random-access memory (RAM) or the like mounted in a travel control device for vehicle 101 is acquired. Next, in step S102, lane shape information included in the map information is acquired from the map unit 70. In step S103, information on the lane shape in the vicinity of the host vehicle is acquired on the basis of the image information acquired by the camera 50. Next, in step S104, the travel trajectories of surrounding vehicles are computed on the basis of the information on the relative positions and the relative speeds of the vehicles in the vicinity of the host vehicle with respect to the host vehicle output by the camera 50 or the radar unit 60. In the following step S105, the lane shape information acquired in steps S102 and S103 is compared with the shape of the travel trajectories of the other vehicles acquired in S104, the similarity degree of the shape is computed, and a lane shape having the similarity degree equal to or greater than a predetermined value is selected in step S106. Then, the lane shape selected in step S107 is compared with the current target route acquired in step S101 to determine whether the lane shape matches the target route. When a positive determination is made here, that is, when the lane shape selected in step S106 matches the current target route, the route does not need to be corrected, and the processing is temporarily terminated. On the other hand, when a negative determination is made in step S107, which means the lane shape selected in step S106 does not match the current target route, the target route is corrected on the basis of the lane shape, and the processing is temporarily terminated.

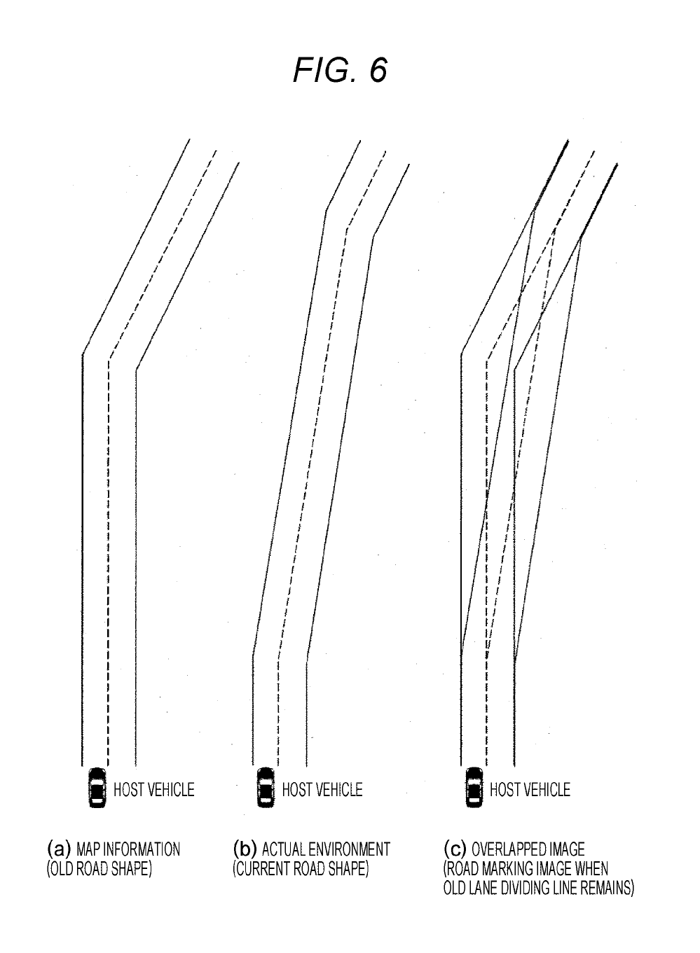

The above processing is described with reference to FIGS. 6 to 9. FIG. 6(a) shows a lane shape on the basis of map information, but differs from an actual environment in FIG. 6(b) showing a temporary lane dividing line due to road construction or the like. FIG. 6(c) is a diagram in which FIG. 6(a) and FIG. 6(b) are overlapped. In addition to the temporary lane dividing line, the original lane dividing line also remains as the road markings, and FIG. 6(c) shows a travel environment which is difficult to judge a lane to travel on even when a person drives.

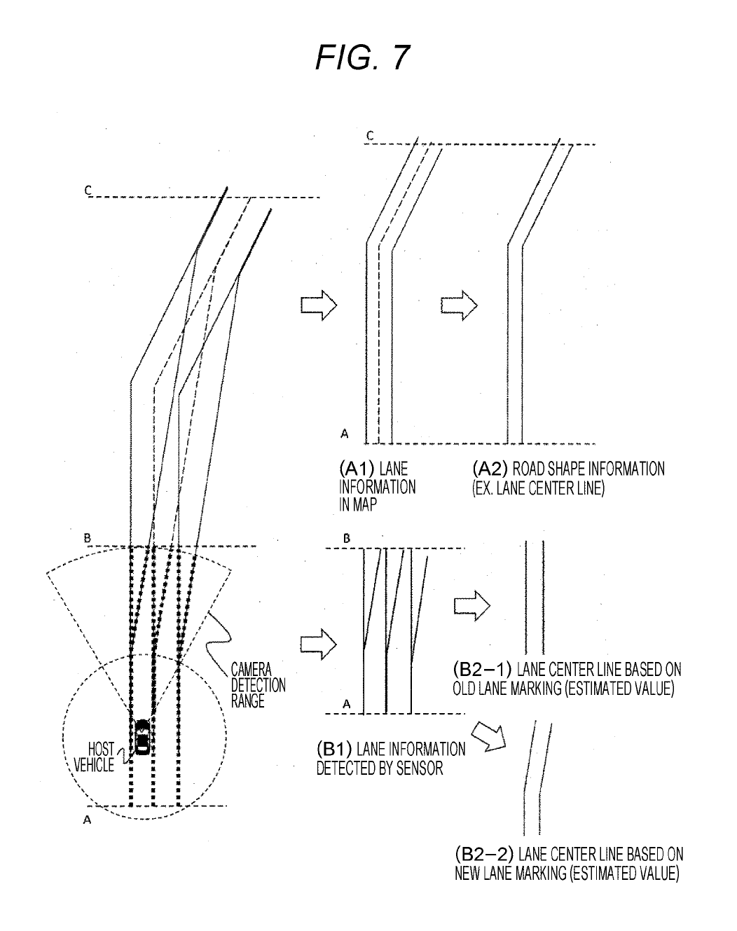

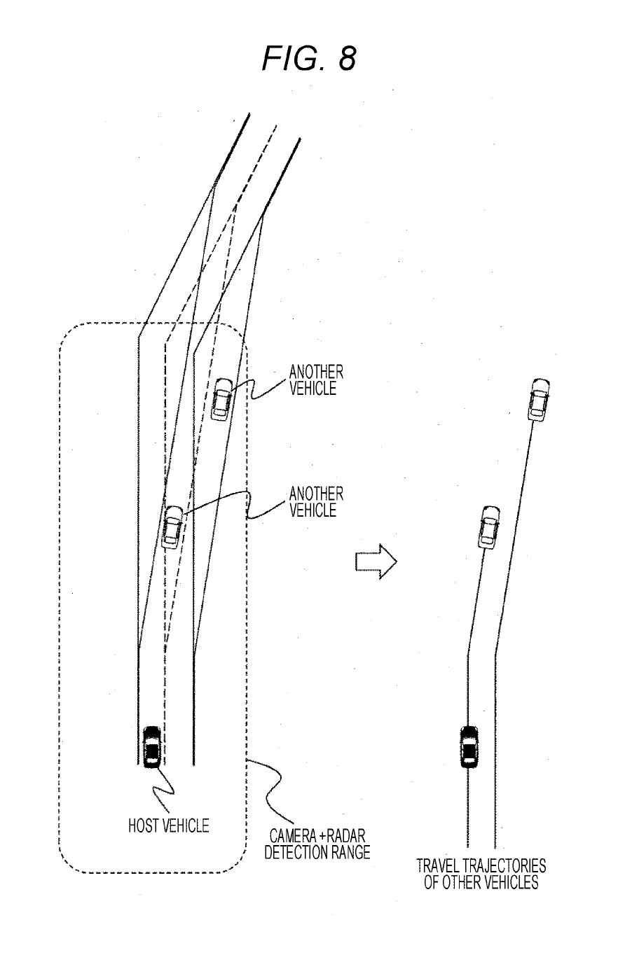

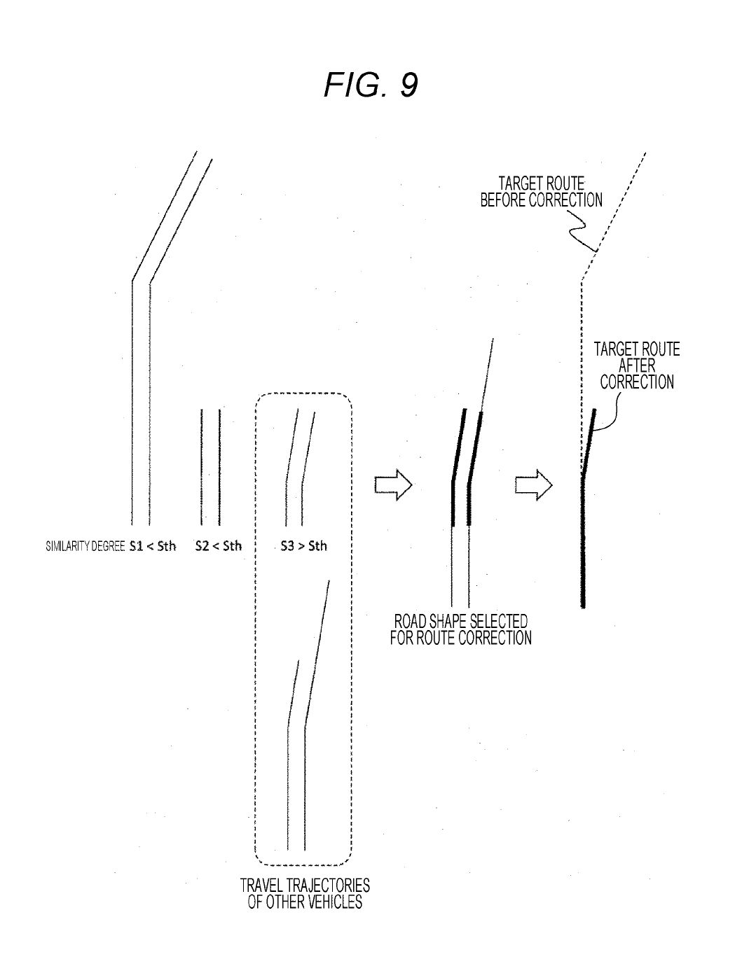

Here, the lane shape on the basis of the map acquired in step S102 is shown in FIG. 7(A1) or FIG. 7(A2). The lane shape on the basis of the sensor information acquired in step S103 is shown in FIG. 7(B1) or FIG. 7(B2). FIG. 7(B2-1) and FIG. 7(B2-2) show that the sensor detects both of the original lane dividing line and the temporary lane dividing line as described above. On the other hand, in step S104, the travel trajectories of other vehicles in the vicinity of the host vehicle are computed as shown in FIG. 8. Then, as shown in FIG. 9, each lane shape information in FIG. 7(A1), FIG. 7(B2-1), and FIG. 7(B2-2) is compared with the travel trajectories of the other vehicles shown in FIG. 8. When each similarity degree is equal to or greater than the predetermined value Sth, the target route is corrected on the basis of the travel trajectories of the other vehicles and the lane shape information similar to the travel trajectories.

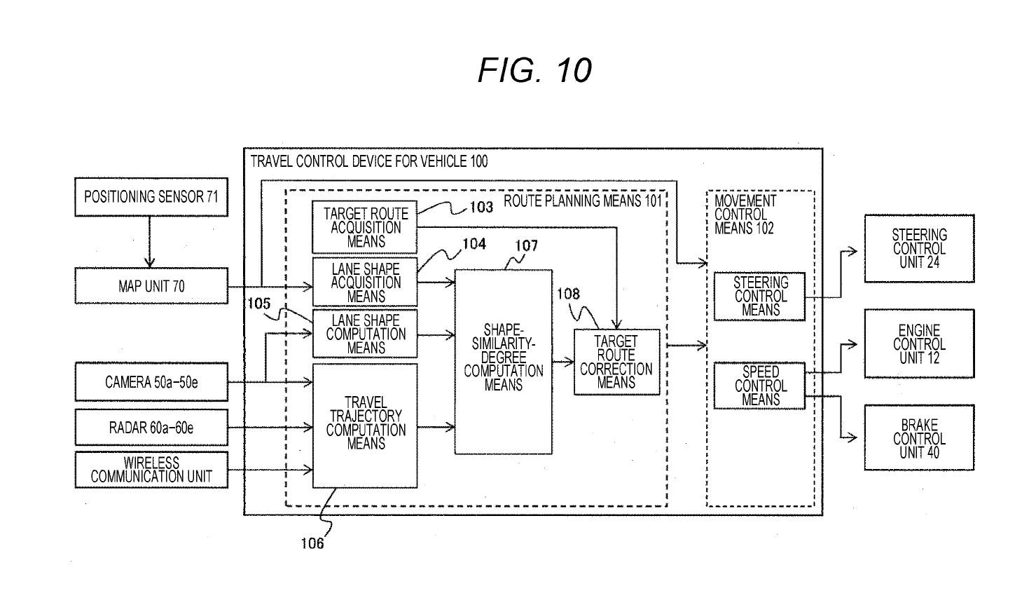

As described above, in a travel environment in which the reliability of the lane shape information obtained from the map or by the sensors is lowered, it is possible to safely continue the traveling control of the vehicle by taking the traveling history of the surrounding vehicles into consideration. Various design changes can be made without departing from the gist of the present invention. For example, as shown in FIG. 10, by providing a wireless communication unit and acquiring information on the positions and speeds of other vehicles by inter-vehicle communication, it is possible to acquire information on an area that cannot be detected by the sensors of the host vehicle, and to improve the reliability and accuracy in the computation of the travel trajectories of other vehicles. Furthermore, by communicating with a data center or the like to accumulate, in the data center, traveling information on a vehicle traveling in a road section before the host vehicle travels on the road section, and acquiring the traveling information when the vehicle travels, it is possible to increase the information amount relating to the travel trajectories of other vehicles. Moreover, by, for example, statistically excluding traveling information on a vehicle that has changed lanes by chance in the corresponding road section, it is possible to correct the route to a more appropriate and safer target route.

### REFERENCE SIGNS LIST

100 travel control device for vehicle
101 route planning means
106 travel trajectory computation means
107 shape-similarity-degree computation means
108 target route correction means

1. A travel control device for vehicle, the device comprising:
a travel route computation means for computing a travel route of a host vehicle on the basis of acquired map information;
a travel environment recognition means for detecting a travel environment in the vicinity of the host vehicle;
a travel trajectory computation means for computing a travel trajectory of another vehicle detected by the travel environment recognition means; and
a route planning means for planning a target route on which the host vehicle travels, wherein
the route planning means comprises a correction means for correcting, when the travel route differs from the travel environment, the target route on the basis of the travel trajectory of the other vehicle.

2. The travel control device for vehicle according to claim 1, wherein
the consistency determination means determines consistency with the travel trajectory of the other vehicle when a lane shape acquired from the map information differs from the travel route detected by the travel environment recognition means.

3. The travel control device for vehicle according to claim 1, wherein
the route planning means comprises a target route correction means for correcting the target route on the basis of the travel route determined to be consistent by the consistency determination means.

4. The travel control device for vehicle according to claim 1, comprising:
a lane shape acquisition means for acquiring a lane shape on the basis of information acquired from the map information; and
a shape-similarity-degree computation means for computing a similarity degree between the travel route detected by the travel environment recognition means, the computed travel trajectory of the other vehicle, and the acquired lane shape, wherein
the shape-similarity-degree computation means outputs the lane shape or the travel route having the computed similarity degree equal to or greater than a predetermined value.

5. The travel control device for vehicle according to claim 4, wherein
the travel control device for vehicle corrects the target route on the basis of the output lane shape or travel trajectory.
